(19) United States
(12) Patent Application Publication
(10) Pub. No.: US 2025/0023049 A1
(43) Pub. Date: Jan. 16, 2025

(54) BINDER, POSITIVE ELECTRODE PLATE, METHOD FOR PREPARING POSITIVE ELECTRODE PLATE

(71) Applicant: Ningde Amperex Technology Limited, Ningde (CN)

(72) Inventor: Changtong ZHOU, Ningde (CN)

(73) Assignee: Ningde Amperex Technology Limited, Ningde (CN)

(21) Appl. No.: 18/765,667

(22) Filed: Jul. 8, 2024

(30) Foreign Application Priority Data
Jul. 7, 2023 (CN) 202310826452.4

(51) Int. Cl. H01M 4/62; H01M 4/02; H01M 4/04; H01M 10/0525

(52) U.S. Cl. CPC H01M 4/622; H01M 4/0404; H01M 10/0525; H01M 2004/021; H01M 2004/028

(57) ABSTRACT

A binder includes a polymer. The polymer is polymerized from at least a first monomer and a second monomer. The first monomer assumes a structure represented by Formula I, and the second monomer assumes a structure represented by Formula II:

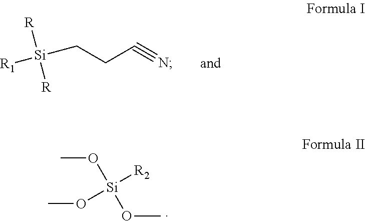

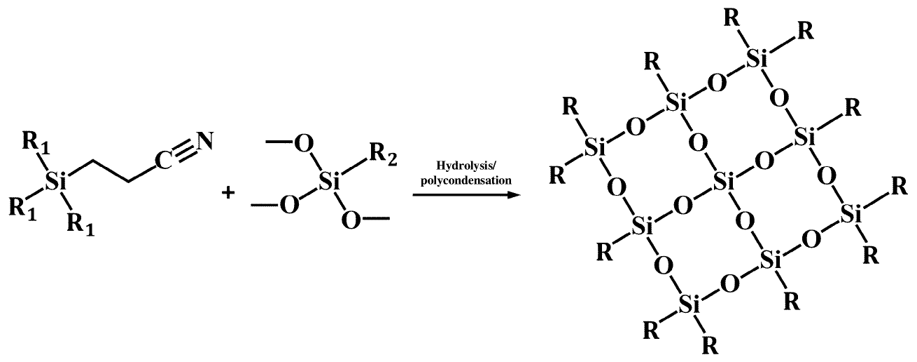

The binder has high flexibility and can effectively avoid a low compaction density caused by hardness and brittleness of the binder in use. The electrode plate prepared from the binder exhibits a strong bonding force and a strong cohesive force, thereby avoiding shedding of active material powder and debonding of a coating film from the electrode plate during cycling, avoiding drastic loss of the compaction density caused by an excessive rebound of the electrode plate, and improving cycle stability of the electrochemical device.

### CROSS-REFERENCE TO RELATED APPLICATIONS

This application claims priority to the Chinese Patent Application Ser. No. 202310826452.4, filed on Jul. 7, 2023, the content of which is incorporated herein by reference in its entirety.

### TECHNICAL FIELD

This application relates to the technical field of lithium batteries, and in particular, to a binder, a positive electrode plate, and a method for preparing the positive electrode plate.

### BACKGROUND

Currently, a lithium-ion battery positive electrode typically uses polyvinylidene difluoride (PVDF) as a binder. Generated in the form of an intermolecular force, the bonding effect between the PVDF and an active material is relatively weak. During charging and discharging of an electrode plate, the active material is prone to be debonded, thereby impairing the performance of the battery. In addition, the PVDF is prone to decompose at high temperature to produce hydrogen fluoride that corrodes the substrate and reduces the lifespan of the battery. In addition, in a process of preparing a slurry of the active material, free amines in an N-methyl-pyrrolidone (NMP) solvent attack the PVDF molecular chain to trigger dehydrofluorination reactions to form double bonds. The double bonds enable a crosslinking process that builds a three-dimensional network structure, thereby causing the slurry to gel. In addition, the PVDF is of low mechanical ductility and low affinity for electrode materials, thereby being unable to effectively avoid the problem that the positive active material is crushed and swelling after long-term cycling. A polyacrylonitrile (PAN) binder and a polyimide (PI) binder have been disclosed in the prior art. The PAN binder is improved in terms of bonding strength compared to the PVDF, but is not flexible enough at normal temperature, thereby resulting in a low compaction density (P.D) of the electrode plate. In addition, a PAN copolymer swells to a high degree in an electrolyte solution, thereby further reducing the compaction density after the electrode plate rebounds. The PI binder is thermodynamically stable, but is not flexible enough, thereby resulting in inferior mechanical performance of the electrode plate.

### SUMMARY

In view of the situation above, this application provides a binder, a positive electrode plate, and a method for preparing the positive electrode plate. The binder disclosed herein is of high flexibility and can effectively avoid drastic loss of compaction density caused by hardness and brittleness of the binder in use. In addition, the electrode plate prepared from the binder exhibits a strong bonding force and a strong cohesive force, thereby avoiding the problems such as shedding of active material powder and debonding of a coating film from the electrode plate during cycling, and drastic loss of the compaction density caused by an excessive rebound of the electrode plate.

According to a first aspect, this application provides a binder. The binder includes a polymer. The polymer is polymerized from at least a first monomer and a second monomer.

The first monomer assumes a structure represented by Formula I:

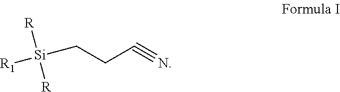

In Formula I, R₁ is at least one selected from halogen or a C₁ to C₂ alkoxy.

The second monomer assumes a structure represented by Formula II:

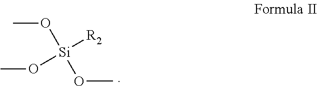

In Formula II, R₂ is at least one selected from a group represented by Formula c or a group represented by Formula d:

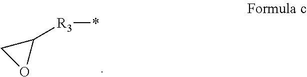

In Formula c, R₃ is selected from a C₁ to C₃ alkyl or a C₁ to C₅ oxygen-containing alkyl, and * is a linking end.

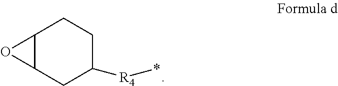

In Formula d, R₄ is a C₁ to C₃ alkyl, and * is a linking end.

This application provides a novel organosilicone positive electrode binder capable of self-crosslinking at high temperature. The binder is prepared by hydrolysis or polycondensation of the first monomer and the second monomer in an organic solvent. For example, as shown in the FIGURE, a silicon-oxygen framework endows the binder with high flexibility to avoid the hardness and brittleness of the binder in use. After the electrode plate is cold-pressed, the binder is conducive to achieving a high compaction density of the electrode plate, thereby increasing the energy density of a battery cell containing the electrode plate. Moreover, a strongly polar cyano group in a side chain of the organosilicone binder makes the organosilicone binder highly resistant to oxidation in a high-voltage system on the one hand, and on the other hand, can interact with a hydroxyl group on the surface of the positive active material to form strong hydrogen bonding and dipole-dipole interactions, thereby distributing the binder more evenly on the surface of the active material, and increasing the bonding strength of the active material of the electrode. In addition, in a process of drying the electrode plate, an epoxy group in a binder molecule can also react with a hydroxyl group in an adjacent molecule and the hydroxyl group on the surface of the positive active material to form an ether bond, thereby increasing the cohesive force of the electrode plate, reducing the rebound of the electrode plate, and further increasing the energy density of the battery cell.

In some embodiments, in Formula I, R₁ is at least one selected from —Cl, —OCH₃, or —OCH₂CH₃.

In some embodiments, in Formula II, R₂ is at least one selected from

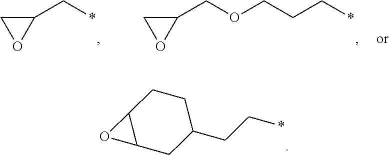

In some embodiments, based on a total mass of the binder, a sum of mass percentages of the first monomer and the second monomer is denoted as W, satisfying W≥90 wt %. A molar ratio of the first monomer to the second monomer is 1:(0.02 to 0.2). Preferably, the molar ratio of the first monomer to the second monomer is 1:(0.08 to 0.12). By controlling the molar ratio of the first monomer to the second monomer to fall within the above range, this application endows the prepared binder with high flexibility. The electrode plate prepared from the binder possesses a high bonding force, a high cohesive force, and a high compaction density, thereby increasing the energy density of the battery, ensuring structural stability of the electrode plate during cycling, and further improving the cycle performance of the electrochemical device.

In some embodiments, a number-average molecular weight of the binder is 60,000 to 100,000. Preferably, the number-average molecular weight of the binder is 80,000 to 100,000.

In some embodiments, a glass transition temperature of the binder is −100° C. to −10° C. Preferably, the glass transition temperature of the binder is −70° C. to −40° C.

By controlling the molar ratio of the first monomer to the second monomer, the number-average molecular weight of the binder, and the glass transition temperature of the binder to fall within the above ranges, this application endows the prepared organosilicone binder with higher adhesiveness, and more favorably improves the flexibility of the positive electrode plate containing the binder, thereby improving the processability of the positive electrode plate and achieving a high compaction density.

According to a second aspect, this application provides a positive electrode plate. The positive electrode plate includes a positive current collector and a positive active material layer disposed on at least one surface of the positive current collector. The positive active material layer includes a positive active material, a conductive agent, and the foregoing binder.

In some embodiments, a mass percent of the binder in the positive active material layer is 0.8% to 2.0%.

In some embodiments, a bonding force between the positive active material layer and the positive current collector is 15 N/m to 25 N/m.

In some embodiments, a cohesive force of the positive active material is 60 N/m to 80 N/m.

When the mass percent of the binder, the bonding force between the positive active material layer and the positive current collector, and the cohesive force of the positive active material are all appropriate, the prepared positive electrode plate is of higher structural stability and is more conducive to improving the cycle performance of the electrochemical device.

According to a third aspect, this application provides a method for preparing a positive electrode plate. The method includes the following steps:
(1) mixing the first monomer, the second monomer, a catalyst, and a solvent, and stirring at an ambient temperature of 25° C. to 45° C. and a rotation speed of 500 rpm to 700 rpm for 6 h to 10 h to obtain a binder dispersion solution;
(2) mixing the positive active material, the binder dispersion solution obtained in step (1), a conductive agent, and a solvent to obtain a positive electrode slurry; and
(3) coating the positive current collector with the positive electrode slurry obtained in step (2), and drying the slurry to obtain a positive electrode plate. The solvent in step (1) may be the same as the solvent in step (2). The specific type of the solvent may be selected by a conventional method in the prior art, and is not limited herein.

In some embodiments, in step (1), a solid content of the binder dispersion solution is 8 wt % to 12 wt %, and a viscosity of the binder dispersion solution is 1600 mPa·s to 2600 mPa·s. Preferably, the solid content of the binder dispersion solution is 10.5 wt % to 11.5 wt %, and the viscosity of the binder dispersion solution is 2200 mPa·s to 2400 mPa·s.

In some embodiments, in step (2), a mass ratio between the positive active material, the binder, and the conductive agent is (96 to 98):(1 to 2):(1 to 2).

The technical solutions provided in some embodiments of this application bring at least the following beneficial effects:

This application provides a novel organosilicone positive electrode binder capable of self-crosslinking at high temperature. The silicon-oxygen framework in molecules of the binder endows the binder with high flexibility to avoid the hardness and brittleness of the binder in use. After the electrode plate prepared from this binder is cold-pressed, a high compaction density can be achieved, thereby increasing the energy density of a battery cell. Moreover, a strongly polar cyano group in a side chain of the organosilicone binder makes the organosilicone binder highly resistant to oxidation in a high-voltage system on the one hand, and on the other hand, can interact with a hydroxyl group on the surface of the positive active material to form strong hydrogen bonding and dipole-dipole interactions, thereby distributing the binder more evenly on the surface of the active material, increasing the bonding strength of the active material of the electrode, and avoiding the problems such as film debonding and powder shedding during use of the binder. At the same time, in a process of drying the electrode plate, an epoxy group in the binder molecules can react with the hydroxyl group in the adjacent molecules and the hydroxyl group on the surface of the active material to form an ether bond, thereby greatly increasing the cohesive force of the electrode plate, reducing the rebound of the electrode plate, and maintaining a high compaction density of the electrode plate.

### BRIEF DESCRIPTION OF DRAWINGS

To describe the technical solutions in some embodiments of this application more clearly, the following outlines the drawings to be used in the embodiments. Evidently, the drawings outlined below are merely a part of embodiments of this application. A person skilled in the art may derive other drawings from the outlined drawings without making any creative efforts.

FIGURE shows a schematic diagram of synthesis of a binder according to this application.

### DETAILED DESCRIPTION

To make the objectives, technical solutions, and advantages of this application clearer, the following describes this application in further detail with reference to drawings and embodiments. Understandably, the specific embodiments described herein are merely intended to explain this application, but are not intended to limit this application.

### Binder

According to a first aspect, an embodiment of this application provides a binder, specifically, a binder applicable to a positive electrode plate. The binder includes a polymer. The polymer is polymerized from at least a first monomer and a second monomer.

The first monomer assumes a structure represented by Formula I:

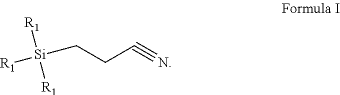

In Formula I, R₁ is at least one selected from halogen or a C₁ to C₂ alkoxy.

The second monomer assumes a structure represented by Formula II:

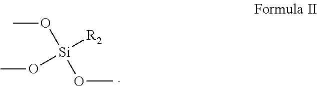

In Formula II, R₂ is at least one selected from a group represented by Formula c or a group represented by Formula d:

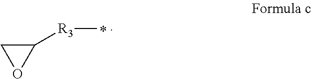

In Formula c, R₃ is selected from a C₁ to C₃ alkyl or a C₁ to C₅ oxygen-containing alkyl;

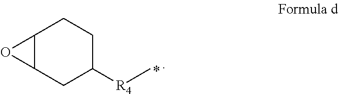

In Formula d, R₄ is a C₁ to C₃ alkyl.

In some embodiments, R₁ is at least one group selected from —Cl, —OCH₃, or —OCH₂CH₃. R₂ is at least one group selected from

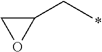

(epoxy propyl),

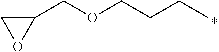

(epoxy propyl propoxy), or

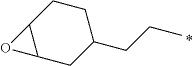

(epoxy cyclohexylethyl).

Referring to the FIGURE, R in the FIGURE is selected from —OH, cyanoethyl

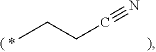

epoxy propyl, epoxy propyl propoxy, or epoxy cyclohexylethyl.

In some embodiments, based on a total mass of the binder, a sum of mass percentages of the first monomer and the second monomer is denoted as W, satisfying W≥90 wt %. A molar ratio of the first monomer to the second monomer is 1:(0.02 to 0.2).

As an example, based on a total mass of the binder, a sum W of the mass percentages of the first monomer and the second monomer is 90 wt %, 92 wt %, 94 wt %, 95 wt %, 96 wt %, 98 wt %, 100 wt %, or a value falling within a range formed by any two thereof.

As an example, the molar ratio of the first monomer to the second monomer is 1:0.02, 1:0.04, 1:0.06, 1:0.08, 1:0.1, 1:0.12, 1:0.14, 1:0.16, 1:0.18, 1:0.2, or a value falling within a range formed by any two thereof.

In some embodiments, the number-average molecular weight of the binder is 60,000 to 100,000.

As an example, the number-average molecular weight of the binder is 60,000, 70,000, 80,000, 90,000, 100,000, or a value falling within a range formed by any two thereof.

In some embodiments, the glass transition temperature of the binder is −100° C. to −10° C.

As an example, the glass transition temperature of the binder is −100° C., −90° C., −80° C., −70° C., −60° C., −50° C., −40° C., −30° C., −20° C., −10° C., or a value falling within a range formed by any two thereof.

### Electrochemical Device

A second aspect of this application provides an electrochemical device. The electrochemical device includes a positive electrode plate, a negative electrode plate, a separator, and an electrolyte solution.

### Positive Electrode Plate

The positive electrode plate includes a positive current collector and a positive active material layer disposed on at least one surface of the positive current collector. The positive active material layer includes a positive active material, a conductive agent, and the binder disclosed in the first aspect. The positive current collector is not particularly limited in this application, as long as the objectives of this application can be achieved. For example, the positive current collector may include aluminum foil, aluminum alloy foil, a composite current collector (for example, a composite current collector formed by a metal-clad polymer), or the like. The thickness of the positive current collector is not particularly limited in this application, as long as the objectives of this application can be achieved. For example, the thickness of the positive current collector is 5 μm to 12 μm. The positive active material layer includes a positive active material. The type of the positive active material is not particularly limited herein, as long as the objectives of this application can be achieved. For example, the positive active material may include, but is not limited to, at least one of lithium nickel cobalt manganese oxide, lithium nickel cobalt aluminum oxide, lithium iron phosphate, a lithium-rich manganese-based material, lithium cobalt oxide, lithium manganese oxide, or lithium manganese iron phosphate. The thickness of the positive active material layer is not particularly limited herein, as long as the objectives of this application can be achieved. For example, the thickness of the positive active material layer is 30 μm to 120 μm. In this application, the type of the conductive agent is not particularly limited, as long as the objectives of this application can be achieved. For example, the conductive agent may include, but is not limited to, at least one of conductive carbon black, carbon nanotubes (CNTs), carbon fibers, Ketjen black, graphene, a metal material, or a conductive polymer.

In some embodiments, a mass percent of the binder in the positive active material layer is 0.8% to 2.0%.

As an example, the mass percent of the binder in the positive active material layer is 0.8%, 1.0%, 1.2%, 1.4%, 1.5%, 1.6%, 1.8%, 2.0%, or a value falling within a range formed by any two thereof.

In some embodiments, a bonding force between the positive active material layer and the positive current collector is 15 N/m to 25 N/m.

As an example, the bonding force between the positive active material layer and the positive current collector is 15 N/m, 16 N/m, 17 N/m, 18 N/m, 19 N/m, 20 N/m, 21 N/m, 22 N/m, 23 N/m, or 24 N/m, 25 N/m, or a value falling within a range formed by any two thereof.

In some embodiments, the cohesive force of the positive active material is 60 N/m to 80 N/m.

As an example, the cohesive force of the positive active material is 60 N/m, 63 N/m, 65 N/m, 68 N/m, 70 N/m, 72 N/m, 75 N/m, 78 N/m, or 80 N/m, or a value falling within a range formed by any two thereof.

### Method for Preparing a Positive Electrode Plate

A method for preparing the positive electrode plate according to an embodiment of this application includes the following steps:
(1) Mixing the first monomer, the second monomer, a catalyst, and a solvent, and stirring at an ambient temperature of 25° C. to 45° C. and a rotation speed of 500 rpm to 700 rpm for 6 h to 10 h to obtain a binder dispersion solution.

As an example, mixing ammonium hydroxide (catalyst) and NMP, and then adding the first monomer and the second monomer at a molar ratio of 1:(0.02 to 0.2), and stirring at room temperature of 25° C. and a rotation speed of 600 rpm for 8 h to obtain a binder dispersion solution, so that the solid content of the binder dispersion solution falls within a range of 8 wt % to 12 wt %, and the viscosity of the binder dispersion solution falls within a range of 1600 mPa·s to 2600 mPa·s.

Based on the total mass of the binder dispersion solution, the mass percent of the catalyst is 0.25 wt % to 4 wt %. As an example, the mass percent of the catalyst is 0.25 wt %, 0.5 wt %, 0.8 wt %, 1 wt %, 1.5 wt %, 2 wt %, 2.5 wt %, 3 wt %, 3.5 wt %, 4 wt %, or a value falling within a range formed by any two thereof.
(2) mixing the positive active material, the binder dispersion solution obtained in step (1), a conductive agent, and a solvent to obtain a positive electrode slurry; and

As an example, dispersing the positive active material lithium cobalt oxide (LiCoO₂), the above-prepared binder dispersion solution, and conductive carbon black in an NMP solvent, and stirring well to obtain a positive electrode slurry in which the solid content is 65 wt % to 75 wt %. The mass ratio between LiCoO₂, the binder, and the conductive carbon black in the solid constituents is (96 to 98):(1 to 2):(1 to 2).
(3) coating the positive current collector with the positive electrode slurry obtained in step (2), and drying the slurry to obtain a positive electrode plate.

As an example, applying the positive electrode slurry evenly onto one surface of a positive current collector aluminum foil with a thickness of 5 μm to 12 μm, and drying the slurry at 110° C. to 130° C. to obtain a positive electrode plate coated with a positive active material layer that is 30 μm to 120 μm thick on a single side. Subsequently, repeating the foregoing steps on the other surface of the positive current collector aluminum foil to obtain a positive electrode plate coated with the positive active material layer on both sides. Cold-pressing and cutting the coated positive electrode plate into sheets of 70 mm×800 mm for future use.

### Negative Electrode Plate

The negative electrode plate includes a negative current collector and a negative active material layer disposed on a surface of the negative current collector. The negative active material layer includes a negative active material. The negative active material includes a silicon-based material. The negative current collector is not particularly limited herein, as long as the objectives of this application can be achieved. For example, the negative current collector may include copper foil, copper alloy foil, nickel foil, stainless steel foil, titanium foil, foamed nickel, foamed copper, or a composite current collector (for example, a composite current collector formed by a metal-clad polymer), or the like. The thickness of the negative current collector is not particularly limited herein as long as the objectives of this application can be achieved. For example, the thickness of the negative current collector is 5 μm to 12 μm. In some embodiments, the silicon-based material includes at least one of simple-substance silicon, a silicon-oxygen composite material, or a silicon-carbon composite material. In some embodiments, the negative active material may further include other negative active materials known in the art other than the foregoing silicon-based materials. For example, the other negative active materials known in the art may include, but are not limited to, at least one of natural graphite, artificial graphite, mesocarbon microbeads, hard carbon, soft carbon, Li—Sn alloy, Li—Sn—O alloy, or Li—Al alloy. In some embodiments, based on the mass of the negative active material, a mass percent of the silicon-based material is 40% to 90%. The negative active material layer may further include a binder and a thickener applicable to a negative electrode. The types of the binder and thickener applicable to a negative electrode are not particularly limited herein, as long as the objectives of this application can be achieved. For example, the binder applicable to a negative electrode may include, but is not limited, to at least one of polyvinyl alcohol, polyvinyl chloride, carboxylated polyvinyl chloride, polyvinyl fluoride, polyvinylpyrrolidone, polyurethane, polytetrafluoroethylene, polyvinylidene difluoride, styrene-butadiene rubber, or acrylated styrene-butadiene rubber. The thickener may include, but is not limited to, at least one of sodium carboxymethyl cellulose or lithium carboxymethyl cellulose. The negative active material layer may further include a conductive agent. The type of the conductive agent is not particularly limited herein, as long as the objectives of this application can be achieved. For example, the conductive agent may include, but is not limited to, at least one of conductive carbon black, carbon nanotubes, carbon fibers, Ketjen black, graphene, a metal material, or a conductive polymer. The mass percentages of the negative active material, binder, conductive agent, and thickener in the negative active material layer are not particularly limited herein, and may be selected by a person skilled in the art as actually required, as long as the objectives of this application can be achieved. The negative electrode plate may be prepared with reference to a conventional method in this field.

### Separator

The separator is not particularly limited herein, and may be any well-known porous separator that is electrochemically stable and chemically stable, for example, may be a single-layer or multi-layer film that is one or more of glass fiber, non-woven fabric, polyethylene (PE), polypropylene (PP), and polyvinylidene difluoride (PVDF). The separator may be prepared with reference to a conventional method in this field.

As an example, this application uses a 16 μm-thick porous polyethylene thin film as a separator.

### Electrolyte Solution

The electrolyte solution includes an organic solvent, an electrolyte lithium salt, and an additive. The type of the organic solvent is not particularly limited herein, and may be selected according to actual needs.

As an example, the organic solvent may include one or more of, and preferably two or more of: ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethylene propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), sulfolane (SF), methyl sulfonyl methane (MSM), ethyl methyl sulfone (EMS), or (ethylsulfonyl)ethane (ESE).

As an example, the electrolyte lithium salt includes one or more of LiPF₆ (lithium hexafluorophosphate), LiBF₄ (lithium tetrafluoroborate), LiClO₄ (lithium perchlorate), LiAsF₆ (lithium hexafluoroarsenate), LiFSI (lithium bisfluorosulfonimide), LiTFSI (lithium bistrifluoromethanesulfonimide), LiTFS (lithium trifluoromethanesulfonate), LiDFOB (lithium difluoro(oxalato)borate), LiBOB (lithium bis(oxalato)borate), LiPO2F₂ (lithium difluorophosphate), LiDFOP (lithium difluoro(bisoxalato)phosphate), or LiTFOP (lithium tetrafluoro(oxalato)phosphate).

Optionally, the electrolyte solution further includes an additive. The type of the additive is not particularly limited herein, and may be any additive suitable for use in a lithium-ion battery and may be selected according to actual needs. As an example, the additive may be one or more of vinylene carbonate (VC), vinyl ethylene carbonate (VEC), succinonitrile (SN), adiponitrile (AND), 1,3-propene sultone (PST), tris(trimethylsilane)phosphate (TMSP), or tris(trimethylsilane)borate (TMSB).

The electrochemical device may be prepared with reference to a conventional method in this field. An exemplary method is: Stacking the positive electrode plate, the separator, and the negative electrode plate in sequence in such a way that the separator is located between the positive electrode plate and the negative electrode plate to serve a function of separation, so as to obtain an electrode assembly, or, winding the above components to obtain an electrode assembly; and putting the electrode assembly into a packaging shell, injecting an electrolyte solution, and sealing the shell to obtain an electrochemical device. The electrolyte solution may be prepared with reference to a conventional method in this field.

The electrochemical device of this application may be any device in which an electrochemical reaction occurs. Specific examples of the electrochemical device include all types of primary batteries or secondary batteries. In particular, the electrochemical device is a lithium secondary battery, including a lithium metal secondary battery, a lithium-ion secondary battery, a lithium polymer secondary battery, or a lithium-ion polymer secondary battery.

The implementations of this application are described below in more detail with reference to embodiments and comparative embodiments. Unless otherwise specified, the parts, percentages, and ratios set out herein are based on mass.

### Embodiment 1-1

### (I) Preparing a Lithium-Ion Battery

### (1) Preparing a Binder

Adding an NMP solution and 1% ammonium hydroxide (catalyst) into a three-necked flask, stirring well, and then adding 2-cyanoethyltrichlorosilane (a first monomer) and epoxy propyl trimethoxysilane (a second monomer) at a molar ratio of 1:0.02, and mechanically stirring the mixture at a room temperature of 25° C. and a rotation speed of 600 rpm for 8 hours to obtain a binder dispersion solution. Based on the total mass of the binder dispersion solution, the mass percent of the ammonium hydroxide is 1 wt %, the solid content of the binder dispersion solution is 10 wt %, and the viscosity of the binder dispersion solution is 2080 mPa·s, as detailed in Table 1.

Embodiments 1-2 to 1-10 differ from Embodiment 1-1 in that the molar ratio of the first monomer to the second monomer is further adjusted in Embodiments 1-2 to 1-10, as shown in Table 1.

Embodiments 1-11 to 1-20 differ from Embodiment 1-5 in that the dosage of the catalyst is further adjusted in Embodiments 1-11 to 1-20, as shown in Table 1.

Embodiments 1-21 to 1-24 differ from Embodiment 1-5 in that the types of the first monomer and the second monomer are further adjusted in Embodiments 1-21 to 1-24, as shown in Table 1.

Comparative Embodiment 1 is identical to Embodiment 1-1 except that a commercial binder PVDF (model: Arkema HSV900) is used in place of the organosilicone binder. Comparative Embodiment 2 is identical to Embodiment 1-1 except that commercial polyvinylpyrrolidone (Mw=40000, Sigma aldrich) is used in place of the organosilicone binder. Comparative Embodiment 3 is identical to Embodiment 1-1 except that a commercial binder (model: Yindile 136D) is used in place of the organosilicone binder. Comparative Embodiment 4 is identical to Embodiment 1-1 except that commercial polyvinylimidazole (Mw=400,000, InnoChem) is used in place of the organosilicone binder.

### (2) Preparing a Positive Electrode Plate

Dispersing the positive active material lithium cobalt oxide (LiCoO₂), the above-prepared binder dispersion solution, and conductive carbon black in an NMP solvent, and stirring well to obtain a positive electrode slurry in which the solid content is 70 wt %. The mass ratio between LiCoO₂, the binder, and the conductive carbon black in the solid constituents is 96:2:2. Coating one surface of an 8 μm-thick positive current collector aluminum foil with the positive electrode slurry evenly, and drying the slurry at 120° C. to obtain a positive electrode plate coated with a 70 μm-thick positive active material layer on a single side. Subsequently, repeating the foregoing steps on the other surface of the positive current collector aluminum foil to obtain a positive electrode plate coated with the positive active material layer on both sides. Cold-pressing and cutting the coated positive electrode plate into sheets of 70 mm×800 mm for future use. The mass percent of the binder in the positive active material layer is 2 wt %.

### (3) Preparing a Negative Electrode Plate

Mixing graphite as a negative active material, styrene-butadiene rubber, and sodium carboxymethyl cellulose at a mass ratio of 97.6:1.1:1.3, adding deionized water as a solvent, and stirring well to obtain a negative electrode slurry in which the solid content is 70 wt %. Coating one surface of a 6 μm-thick negative current collector copper foil with the negative electrode slurry evenly, and drying the slurry at 120° C. to obtain a negative electrode plate coated with a 120 μm-thick negative active material layer on a single side. Subsequently, repeating the foregoing step on the other surface of the negative current collector copper foil to obtain a negative electrode plate coated with the negative active material layer on both sides. Cold-pressing and cutting the coated negative electrode plate into sheets of 74 mm×800 mm for future use.

### (4) Preparing an Electrolyte Solution

Mixing propylene carbonate (PC), diethyl carbonate (DEC), and ethylene carbonate (EC) at a mass ratio of 1:1:1 in a dry argon atmosphere glovebox to form an organic solvent, and then adding hexafluorophosphate (LiPF₆) as a lithium salt into the organic solvent to dissolve, and stirring well to obtain an electrolyte solution in which the concentration of the LiPF₆ is 1.15 mol/L.

### (5) Preparing a Lithium-Ion Battery

Stacking the above-prepared positive electrode plate, separator, and negative electrode plate in sequence, and then winding the stacked structure to form an electrode assembly. Welding tabs to the electrode assembly, and then putting the electrode assembly into an aluminum laminated film package. Leaving the packaged electrode assembly in an 80° C. vacuum oven to dehydrate for 12 hours, and then injecting the prepared electrolyte solution. Performing steps such as vacuum sealing, standing, chemical formation (charging the battery at a constant current of 0.02 C until the voltage reaches 3.5 V, and then charging the battery at a constant current of 0.1 C until the voltage reaches 3.9 V), capacity grading, and shaping to obtain a lithium-ion battery.

### (II) Performance Test

### (1) Testing the Viscosity

Measuring the viscosity of the organosilicone binder dispersion solution by using a digital rotational viscometer (Shanghai Jingtian Electronic Instrument Co., Ltd., LVDV 1). Selecting a rotor and a rotation speed as suitable for the binder dispersion solution to be measured. Inserting the rotor slowly into the binder dispersion solution to soak the rotor. Starting and rotating the viscometer when the liquid level of the binder dispersion solution reaches a middle position of the rotor groove. Waiting for two minutes until the readout keeps steady, and collecting the readout. Recording the readout as the viscosity of the prepared binder dispersion solution in units of mPa·s.

### (2) Testing the Bonding Force

Taking a cold-pressed positive electrode plate, and punching the electrode plate through a mold to obtain a test strip 100 mm long and 20 mm wide. Wiping the surface of a steel sheet clean by using alcohol, sticking a double-sided tape (NITTO, NO5000NS) with a length of 55 mm to 70 mm and a width of 20 mm onto the steel sheet, and ensuring that no bubbles are generated. Sticking the test strip onto a middle part of the double-sided tape, with the test side facing down. Connecting and fixing a paper strip to one end of the test strip by using crepe tape (high-viscosity crepe paper), where the length of the paper strip is 50 mm to 75 mm and the width of the paper strip is equal to the width of the test strip. Pushing, by hand, a rubber roller of 2 kg in mass to roll back and forth on the test strip for 4 times to obtain a specimen for test. Testing the specimen by using a tensile tester (Sansi, Instron 3365). Fixing the specimen onto a specimen platform, folding the paper strip upward by 90°, and fixing the paper strip with a jig. Subsequently, using the tensile tester to pull the paper strip slowly at a speed of 10 mm/min until the positive active material layer on the surface of the double-sided tape is detached from the positive current collector, whereupon the test is finished. Averaging out the tensile force values measured in a steady region, and recording the average value as a bonding force between the positive active material and the positive current collector, in units of N/m.

### (3) Testing the Cohesive Force

Taking a cold-pressed positive electrode plate, and punching the electrode plate through a mold to obtain a test strip 80 mm long and 20 mm wide. Wiping the surface of a steel sheet clean by using alcohol, sticking a double-sided tape (NITTO, NO5000NS) with a length of 50 mm to 60 mm and a width of 20 mm onto the steel sheet, and ensuring that no bubbles are generated. Sticking the test strip onto the double-sided tape, with the test side facing up. Sticking a cohesive force-specific green tape (Tuodi adhesive tape, 20 mm wide, 80 mm long) to the middle part of the test strip, cutting out a paper strip 60 mm long and 20 mm wide, and inserting the paper strip into the clearance between the test strip and the green tape, with an overlap length of 15 mm. Pushing, by hand, a rubber roller of 2 kg in mass to roll back and forth on the test strip for 4 times to obtain a specimen for test. Testing the specimen by using a tensile tester (Sansi, Instron 3365). Fixing the specimen onto a specimen platform, folding the paper strip upward by 180°, and fixing the paper strip with a jig. Subsequently, using the tensile tester to pull the paper strip slowly at a speed of 10 mm/min until the green tape is detached from the active material layer on the surface of the positive electrode, whereupon the test is finished. Averaging out the tensile force values measured in a steady region, and recording the average value as a cohesive force of the positive active material, in units of N/m.

### (4) Testing the Compaction Density (P.D)

Disassembling a battery cell that has been subjected to capacity grading, and taking out the positive electrode plate. Placing the positive electrode plate into a ventilating cabinet, and leaving the electrode plate to stand for 30 minutes. Die-cutting the electrode plate into 12 small discs (the area of each disc is 1540.25 mm²) by using a die-cutter. Resetting an electronic scale, putting the small discs onto the weighing platform of the electronic scale by using tweezers, and recording the weight of each small disc, denoted as: m₁, m₂, m₃, m₄, m₅, m₆, m₇, m₈, m₉, m₁₀, m₁₁, and m₁₂. Using a ten-thousandth micrometer to measure the thickness of each small disc at the upper, lower, left, and right positions separately, denoted as: h₁₁, h₁₂, h₁₃, h₁₄, h₂₁, h₂₂, h₂₃, h₂₄, h₃₁, h₃₂, h₃₃, h₃₄, h₄₁, h₄₂, h₄₃, h₄₄, h₅₁, h₅₂, h₅₃, h₅₄, h₆₁, h₆₂, h₆₃, h₆₄, h₇₁, h₇₂, h₇₃, h₇₄, h₈₁, h₈₂, h₈₃, h₈₄, h₉₁, h₉₂, h₉₃, h₉₄, h₁₀₁, h₁₀₂, h₁₀₃, h₁₀₄, h₁₁₁, h₁₁₂, h₁₁₃, h₁₁₄, h₁₂₁, h₁₂₂, h₁₂₃, and h₁₂₄. Averaging out the 4 thickness values of each small disc as: h₁, h₂, h₃, h₄, h₅, h₆, h₇, h₈, h₉, h₁₀, h₁₁, h₁₂. Calculating the compaction density (P.D) of each small disc by using the following formulas:

$$P \cdot {D}_{1} = \frac{{m}_{1} - {m}_{substrate}}{( {h}_{1} - {h}_{substrate} ) \times 1540.25} \times 1000 , P \cdot {D}_{2} = \frac{{m}_{2} - {m}_{substrate}}{( {h}_{2} - {h}_{substrate} ) \times 1540.25} \times 1000 , P \cdot {D}_{3} = \frac{{m}_{3} - {m}_{substrate}}{( {h}_{3} - {h}_{substrate} ) \times 1540.25} \times 1000 , P \cdot {D}_{4} = \frac{{m}_{4} - {m}_{substrate}}{( {h}_{4} - {h}_{substrate} ) \times 1540.25} \times 1000 , P \cdot {D}_{5} = \frac{{m}_{5} - {m}_{substrate}}{( {h}_{5} - {h}_{substrate} ) \times 1540.25} \times 1000 , P \cdot {D}_{6} = \frac{{m}_{6} - {m}_{substrate}}{( {h}_{6} - {h}_{substrate} ) \times 1540.25} \times 1000 , P \cdot {D}_{7} = \frac{{m}_{7} - {m}_{substrate}}{( {h}_{7} - {h}_{substrate} ) \times 1540.25} \times 1000 , P \cdot {D}_{8} = \frac{{m}_{8} - {m}_{substrate}}{( {h}_{8} - {h}_{substrate} ) \times 1540.25} \times 1000 , P \cdot {D}_{9} = \frac{{m}_{9} - {m}_{substrate}}{( {h}_{9} - {h}_{substrate} ) \times 1540.25} \times 1000 , P \cdot {D}_{10} = \frac{{m}_{10} - {m}_{substrate}}{( {h}_{10} - {h}_{substrate} ) \times 1540.25} \times 1000 , P \cdot {D}_{11} = \frac{{m}_{11} - {m}_{substrate}}{( {h}_{11} - {h}_{substrate} ) \times 1540.25} \times 1000 , and P \cdot {D}_{12} = \frac{{m}_{12} - {m}_{substrate}}{( {h}_{12} - {h}_{substrate} ) \times 1540.25} \times 1000.$$

Averaging out the compaction density (P.D) values of the 12 small discs, and recording the average value as the compaction density of each embodiment or comparative embodiment.

### (5) Testing the Glass Transition Temperature

Measuring the glass transition temperature (Tg) of the organosilicone binder by differential scanning calorimetry (DSC). Taking 5 mg of organosilicone binder powder specimen, and heating the specimen from −150° C. to 50° C. at a heating rate of 5° C./min. Acquiring Tg of the organosilicone binder through the DSC curve, in units of ° C.

### (6) Testing the Molecular Weight

Determining the molecular weight distribution of the organosilicone binder by using an Agilent 1200 series liquid chromatograph. Diluting the organosilicone binder solution until the mass concentration of the solution is 0.5%, filtering the solution through an oil-based filter film, and then feeding the specimen for testing.

### (7) Testing the Cycle Performance

Evaluating the cycle performance of the lithium-ion battery by using the capacity retention rate as a performance metric. Putting a chemically formed lithium-ion battery into a 25° C. constant-temperature environment. Charging the lithium-ion battery at a constant current of 0.6 C until the voltage reaches 4.5 V, and then charging the battery at a constant voltage until a cut-off current of 0.05 C. Leaving the fully charged battery to stand for 3 minutes, and then discharging the battery at a current of 0.5 C until the voltage reaches 3.0 V, and recording the discharge energy as Do. Cycling the battery by charging at 0.6 C and discharging at 0.5 C until the battery is charged and discharged for 500 cycles. Recording the discharge capacity at the end of the 500^{th} cycle as D₁. Calculating the capacity retention rate after the lithium-ion battery is cycled at normal temperature (25° C.) for 500 cycles as: capacity retention rate (%)=D₁/D₀×100%.

TABLE 1
(To be continued)

| | | | Molar ratio of |
|---|---|---|---|
| | | | first monomer to |
| | First monomer | Second monomer | second monomer |
| Embodiment 1-1 | 2-cyanoethyl trichlorosilane | Epoxy propyl trimethoxysilane | 1:0.02 |
| Embodiment 1-2 | 2-cyanoethyl trichlorosilane | Epoxy propyl trimethoxysilane | 1:0.04 |
| Embodiment 1-3 | 2-cyanoethyl trichlorosilane | Epoxy propyl trimethoxysilane | 1:0.06 |
| Embodiment 1-4 | 2-cyanoethyl trichlorosilane | Epoxy propyl trimethoxysilane | 1:0.08 |
| Embodiment 1-5 | 2-cyanoethyl trichlorosilane | Epoxy propyl trimethoxysilane | 1:0.1 |
| Embodiment 1-6 | 2-cyanoethyl trichlorosilane | Epoxy propyl trimethoxysilane | 1:0.12 |
| Embodiment 1-7 | 2-cyanoethyl trichlorosilane | Epoxy propyl trimethoxysilane | 1:0.14 |
| Embodiment 1-8 | 2-cyanoethyl trichlorosilane | Epoxy propyl trimethoxysilane | 1:0.16 |
| Embodiment 1-9 | 2-cyanoethyl trichlorosilane | Epoxy propyl trimethoxysilane | 1:0.18 |
| Embodiment 1-10 | 2-cyanoethyl trichlorosilane | Epoxy propyl trimethoxysilane | 1:0.2 |
| Embodiment 1-11 | 2-cyanoethyl trichlorosilane | Epoxy propyl trimethoxysilane | 1:0.1 |
| Embodiment 1-12 | 2-cyanoethyl trichlorosilane | Epoxy propyl trimethoxysilane | 1:0.1 |
| Embodiment 1-13 | 2-cyanoethyl trichlorosilane | Epoxy propyl trimethoxysilane | 1:0.1 |
| Embodiment 1-14 | 2-cyanoethyl trichlorosilane | Epoxy propyl trimethoxysilane | 1:0.1 |
| Embodiment 1-15 | 2-cyanoethyl trichlorosilane | Epoxy propyl trimethoxysilane | 1:0.1 |
| Embodiment 1-16 | 2-cyanoethyl trichlorosilane | Epoxy propyl trimethoxysilane | 1:0.1 |
| Embodiment 1-17 | 2-cyanoethyl trichlorosilane | Epoxy propyl trimethoxysilane | 1:0.1 |
| Embodiment 1-18 | 2-cyanoethyl trichlorosilane | Epoxy propyl trimethoxysilane | 1:0.1 |
| Embodiment 1-19 | 2-cyanoethyl trichlorosilane | Epoxy propyl trimethoxysilane | 1:0.1 |
| Embodiment 1-20 | 2-cyanoethyl trichlorosilane | Epoxy propyl trimethoxysilane | 1:0.1 |
| Embodiment 1-21 | 2-cyanoethyl trimethoxysilane | Epoxy propyl trimethoxysilane | 1:0.1 |
| Embodiment 1-22 | 2-cyanoethyl triethoxysilane | Epoxy propyl trimethoxysilane | 1:0.1 |
| Embodiment 1-23 | 2-cyanoethyl trichlorosilane | (3-epoxy propyl | 1:0.1 |
| | | propoxy)trimethoxysilane | |
| Embodiment 1-24 | 2-cyanoethyl trichlorosilane | 2-(3,4-expoy cyclohexyl)ethyl | 1:0.1 |
| | | trimethoxysilane | |

| | Mass percent | | Solid | | |
|---|---|---|---|---|---|
| | of ammonium | Tg | content | Viscosity | Molecular |
| | hydroxide (%) | (° C.) | (%) | (mPa · S) | weight |
| Embodiment 1-1 | 1.00 | −100 | 10.0 | 2080 | 61200 |
| Embodiment 1-2 | 1.00 | −92 | 10.2 | 2138 | 71200 |
| Embodiment 1-3 | 1.00 | −79 | 10.5 | 2201 | 80800 |
| Embodiment 1-4 | 1.00 | −63 | 10.7 | 2243 | 92400 |
| Embodiment 1-5 | 1.00 | −50 | 11.0 | 2306 | 100000 |
| Embodiment 1-6 | 1.00 | −44 | 11.1 | 2327 | 89600 |
| Embodiment 1-7 | 1.00 | −37 | 11.3 | 2369 | 86400 |
| Embodiment 1-8 | 1.00 | −28 | 11.6 | 2431 | 77600 |
| Embodiment 1-9 | 1.00 | −17 | 11.7 | 2452 | 71200 |
| Embodiment 1-10 | 1.00 | −10 | 12.0 | 2515 | 60800 |
| Embodiment 1-11 | 0.25 | −55 | 8.0 | 1677 | 95600 |
| Embodiment 1-12 | 0.50 | −48 | 9.2 | 1928 | 92400 |
| Embodiment 1-13 | 0.75 | −52 | 9.8 | 2054 | 94400 |
| Embodiment 1-14 | 1.25 | −56 | 10.5 | 2201 | 84000 |
| Embodiment 1-15 | 1.50 | −53 | 10.1 | 2117 | 82800 |
| Embodiment 1-16 | 1.75 | −54 | 9.8 | 2054 | 77600 |
| Embodiment 1-17 | 2.00 | −46 | 9.5 | 1991 | 73200 |
| Embodiment 1-18 | 2.50 | −49 | 9.1 | 1907 | 71200 |
| Embodiment 1-19 | 3.00 | −52 | 8.9 | 1866 | 64800 |
| Embodiment 1-20 | 4.00 | −55 | 8.2 | 1719 | 60000 |
| Embodiment 1-21 | 1.00 | −48 | 10.9 | 2285 | 96800 |
| Embodiment 1-22 | 1.00 | −51 | 10.8 | 2264 | 98400 |
| Embodiment 1-23 | 1.00 | −60 | 11.3 | 2369 | 99600 |
| Embodiment 1-24 | 1.00 | −55 | 11.4 | 2390 | 98000 |

TABLE 2

| | | | P.D after | 500^{th}-cycle |
|---|---|---|---|---|
| | Bonding | Cohesive | capacity | capacity |
| | force | force | grading | retention |
| | (N/m) | (N/m) | (g/cc) | rate (%) |
| Embodiment 1-1 | 15.3 | 65.9 | 3.93 | 87.6 |
| Embodiment 1-2 | 17.8 | 68.2 | 3.94 | 88.4 |
| Embodiment 1-3 | 20.2 | 72.7 | 3.96 | 89.5 |
| Embodiment 1-4 | 23.1 | 76.5 | 3.98 | 91.2 |
| Embodiment 1-5 | 25.0 | 80.0 | 4.00 | 92.5 |
| Embodiment 1-6 | 22.4 | 77.2 | 3.99 | 90.3 |
| Embodiment 1-7 | 21.6 | 74.8 | 3.97 | 89.1 |
| Embodiment 1-8 | 19.4 | 71.3 | 3.96 | 88.6 |
| Embodiment 1-9 | 17.8 | 68.9 | 3.94 | 87.3 |
| Embodiment 1-10 | 15.2 | 66.2 | 3.93 | 86.5 |
| Embodiment 1-11 | 23.9 | 77.4 | 3.99 | 90.8 |
| Embodiment 1-12 | 23.1 | 77.9 | 3.99 | 91.2 |
| Embodiment 1-13 | 23.6 | 78.2 | 3.99 | 90.6 |
| Embodiment 1-14 | 21.0 | 75.3 | 3.98 | 90.2 |
| Embodiment 1-15 | 20.7 | 72.9 | 3.96 | 89.9 |
| Embodiment 1-16 | 19.4 | 69.7 | 3.95 | 89.6 |
| Embodiment 1-17 | 18.3 | 67 | 3.94 | 89.2 |
| Embodiment 1-18 | 17.8 | 64.5 | 3.92 | 88.7 |
| Embodiment 1-19 | 16.2 | 62.6 | 3.91 | 88.3 |
| Embodiment 1-20 | 15.0 | 60.0 | 3.90 | 87.8 |
| Embodiment 1-21 | 24.2 | 79.7 | 4.00 | 92.0 |
| Embodiment 1-22 | 24.6 | 79.3 | 4.00 | 91.2 |
| Embodiment 1-23 | 24.9 | 78.8 | 3.99 | 91.6 |
| Embodiment 1-24 | 24.5 | 79.2 | 4.00 | 90.8 |
| Comparative | 12.5 | 55.4 | 3.88 | 84.4 |
| Embodiment 1 | | | | |
| Comparative | 11.7 | 50.2 | 3.85 | 81.4 |
| Embodiment 2 | | | | |
| Comparative | 12.8 | 53.8 | 3.87 | 83.7 |
| Embodiment 3 | | | | |
| Comparative | 10.5 | 48.6 | 3.84 | 75.5 |
| Embodiment 4 | | | | |

As can be seen from Comparative Embodiments 1 to 4 versus Embodiment 1-1, the binder disclosed herein can significantly improve the bonding strength of the active material of the electrode and the compaction density of the electrode plate in contrast to the conventional binder used in the prior art. In addition, the binder of this application improves the cohesive force of the electrode plate significantly. The lithium-ion battery prepared from the positive electrode plate containing the binder of this application exhibits significantly improved cycle performance.

As can be seen from Embodiments 1-2 to 1-10 versus Embodiment 1-1, the molar ratio of the first monomer to the second monomer is further adjusted during the preparation of the binder in Embodiments 1-2 to 1-10. Therefore, with the change of the molar ratio of the first monomer to the second monomer, the parameter Tg (glass transition temperature), solid content (solid content of the binder dispersion solution), viscosity (viscosity of the binder dispersion solution), and molecular weight (number-average molecular weight of the binder) all change accordingly, and the corresponding effect parameters such as bonding force (bonding force between the positive active material layer and the positive current collector), cohesive force (cohesive force of the positive active material), and post-capacity-grading PD and cycle performance are also slightly different. Especially in Embodiments 1-4 to 1-6, the corresponding bonding force between the positive active material layer and the positive current collector is 22 N/m or above, the cohesive force of the positive active material is 75 N/m or above, and the 500^{th}-cycle capacity retention rate of the lithium-ion batteries prepared from the electrode plate containing the binder is 90% or above.

As can be seen from Embodiments 1-11 to 1-20 versus Embodiment 1-5, in the process of preparing the binder in Embodiments 1-11 to 1-20, the dosage of the catalyst is further adjusted, so that the parameters Tg, solid content, viscosity, and molecular weight change accordingly. Even if the dosage of the catalyst is adjusted, the effect on the parameters Tg, solid content, viscosity, and molecular weight is not significant. The parameters Tg, solid content, viscosity, and molecular weight still change within an appropriate range.

As can be seen from Embodiments 1-21 to 1-24 versus Embodiment 1-5, the types of the first monomer and the second monomer are changed in Embodiments 1-21 to 1-24, but the binder can still achieve the technical effects described herein. Therefore, when the binder of this application is applied to a positive electrode plate, it is ensured that a high bonding force is maintained between the positive active material layer and the current collector, and the positive active material possesses a high cohesive force, and the lithium-ion battery prepared from the positive electrode plate of this application possesses a higher compaction density.

TABLE 3

| | Mass percent | | | |
|---|---|---|---|---|
| | of binder | | | |
| | in positive | | | 500^{th}-cycle |
| | active | Bonding | Cohesive | capacity |
| | material | force | force | retention |
| | layer (%) | (N/m) | (N/m) | rate (%) |
| Embodiment 1-5 | 2 | 25 N/m | 80 N/m | 92.5% |
| Embodiment 1-25 | 0.8 | 16 N/m | 62 N/m | 86.5% |
| Embodiment 1-26 | 1.1 | 18 N/m | 66 N/m | 87.8% |
| Embodiment 1-27 | 1.4 | 21 N/m | 71 N/m | 89.6% |
| Embodiment 1-28 | 1.7 | 23 N/m | 75 N/m | 91.2% |

As can be seen from Table 3, the mass percent, bonding force, and cohesive force of the binder, which fall within the appropriate ranges, coordinate with each other to improve the cycle performance of the electrochemical device. Fine-tuning the above parameters can further improve the cycle performance. For example, when the mass percent of the binder in the positive active material layer is greater than 1.4, the bonding force between the positive active material layer and the positive current collector is 20 N/m or above; when the cohesive force of the positive active material is not less than 70 N/m, the prepared lithium-ion battery can achieve a capacity retention rate of 90% or above after being charged and discharged for 500 cycles. For details, reference may be made to Embodiments 1-5 and 1-28 of this application. In Embodiment 1-5, the 500^{th}-cycle capacity retention rate of the lithium-ion battery is as high as 92.5%.

The foregoing descriptions are merely exemplary embodiments of this application, but are not intended to limit this application. Any modifications, equivalent substitutions, and improvements made without departing from the spirit and principles of this application still fall within the protection scope of this application.

What is claimed is:

1. A binder, comprising a polymer, and the polymer is polymerized from at least a first monomer and a second monomer;
the first monomer has a structure represented by Formula I: 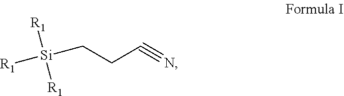
in Formula I, R₁ is at least one selected from halogen or a C₁ to C₂ alkoxy;
the second monomer has a structure represented by Formula II: 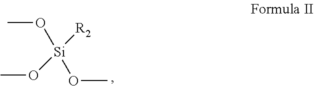
in Formula II, R₂ is at least one selected from a group represented by Formula c or a group represented by Formula d: 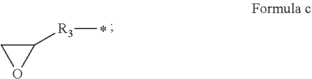
in Formula c, R₃ is selected from a C₁ to C₃ alkyl or a C₁ to C₅ oxygen-containing alkyl; 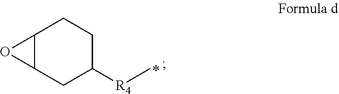
and
in Formula d, R₄ is a C₁ to C₃ alkyl.

2. The binder according to claim 1, wherein,
in Formula I, R₁ is at least one selected from —Cl, —OCH₃, or —OCH₂CH₃; and
in Formula II, R₂ is at least one selected from

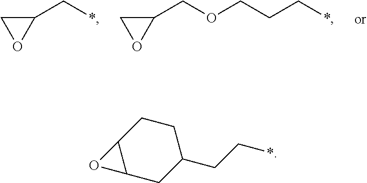

3. The binder according to claim 1, wherein, based on a total mass of the binder, a sum of mass percentages of the first monomer and the second monomer is W, and W≥90 wt %; and
the binder satisfies at least one of the following conditions:
(1) a molar ratio of the first monomer to the second monomer is 1:(0.02 to 0.2);
(2) a number-average molecular weight of the binder is 60,000 to 100,000; or
(3) a glass transition temperature of the binder is −100° C. to −10° C.

4. The binder according to claim 3, wherein the molar ratio of the first monomer to the second monomer is 1:(0.08 to 0.12).

5. The binder according to claim 3, wherein the number-average molecular weight of the binder is 80,000 to 100,000.

6. The binder according to claim 3, wherein the glass transition temperature of the binder is −70° C. to −40° C.

7. A positive electrode plate, comprising a positive current collector and a positive active material layer disposed on at least one surface of the positive current collector; and
the positive active material layer comprises a positive active material, a conductive agent, and a binder;
wherein the binder comprises a polymer, and the polymer is polymerized from at least a first monomer and a second monomer;
the first monomer has a structure represented by Formula I: 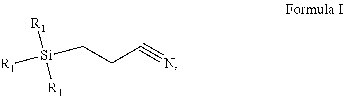
in Formula I, R₁ is at least one selected from halogen or a C₁ to C₂ alkoxy;
the second monomer has a structure represented by Formula II: 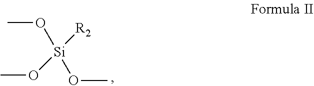
in Formula II, R₂ is at least one selected from a group represented by Formula c or a group represented by Formula d: 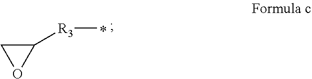
in Formula c, R₃ is selected from a C₁ to C₃ alkyl or a C₁ to C₅ oxygen-containing alkyl; 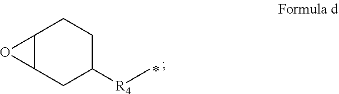
and
in Formula d, R₄ is a C₁ to C₃ alkyl.

8. The positive electrode plate according to claim 7, wherein
in Formula I, R₁ is at least one selected from —Cl, —OCH₃, or —OCH₂CH₃; and
in Formula II, R₂ is at least one selected from

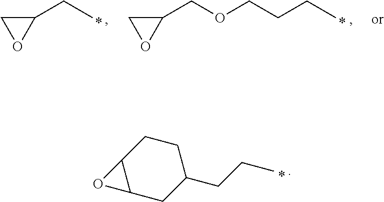

9. The positive electrode plate according to claim 7, wherein, based on a total mass of the binder, a sum of mass percentages of the first monomer and the second monomer is W, and W≥90 wt %; and
the binder satisfies at least one of the following conditions:
(1) a molar ratio of the first monomer to the second monomer is 1:(0.02 to 0.2);
(2) a number-average molecular weight of the binder is 60,000 to 100,000; or
(3) a glass transition temperature of the binder is −100° C. to −10° C.

10. The positive electrode plate according to claim 9, wherein the molar ratio of the first monomer to the second monomer is 1:(0.08 to 0.12).

11. The positive electrode plate according to claim 9, wherein the number-average molecular weight of the binder is 80,000 to 100,000.

12. The positive electrode plate according to claim 9, wherein the glass transition temperature of the binder is −70° C. to −40° C.

13. The positive electrode plate according to claim 7, wherein the positive electrode plate satisfies at least one of the following conditions:
(1) a mass percent of the binder in the positive active material layer is 0.8% to 2.0%;
(2) a bonding force between the positive active material layer and the positive current collector is 15 N/m to 25 N/m; or
(3) a cohesive force of the positive active material is 60 N/m to 80 N/m.

14. A method for preparing the positive electrode plate according to claim 7, the method comprising following steps:
(1) mixing the first monomer, the second monomer, a catalyst, and a solvent, and stirring at an ambient temperature of 25° C. to 45° C. and a rotation speed of 500 rpm to 700 rpm for 6 h to 10 h to obtain a binder dispersion solution;
(2) mixing the positive active material, the binder dispersion solution obtained in the step (1), a conductive agent, and a second solvent to obtain a positive electrode slurry; and
(3) coating the positive current collector with the positive electrode slurry obtained in the step (2), and drying the slurry to obtain a positive electrode plate.

15. The preparation method according to claim 14, wherein the binder comprises a polymer, and the polymer is polymerized from at least a first monomer and a second monomer;
the first monomer has a structure represented by Formula I:
in Formula I, R₁ is at least one selected from —Cl, —OCH₃, or —OCH₂CH₃; and
in Formula II, R₂ is at least one selected from

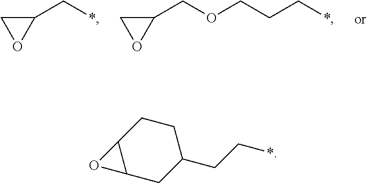

16. The preparation method according to claim 14, wherein, based on a total mass of the binder, a sum of mass percentages of the first monomer and the second monomer is W, and W≥90 wt %; and
the binder satisfies at least one of the following conditions:
(1) a molar ratio of the first monomer to the second monomer is 1:(0.02 to 0.2);
(2) a number-average molecular weight of the binder is 60,000 to 100,000; or
(3) a glass transition temperature of the binder is −100° C. to −10° C.

17. The preparation method according to claim 14, wherein a molar ratio of the first monomer to the second monomer is 1:(0.08 to 0.12).

18. The preparation method according to claim 14, wherein a number-average molecular weight of the binder is 80,000 to 100,000.

19. The preparation method according to claim 14, wherein, in the step (1), a solid content of the binder dispersion solution is 8 wt % to 12 wt %, and a viscosity of the binder dispersion solution is 1600 mPa·s to 2600 mPa·s.

20. The preparation method according to claim 14, wherein, in the step (2), a mass ratio between the positive active material, the binder, and the conductive agent is (96 to 98):(1 to 2):(1 to 2).
